(19) United States
(12) Patent Application Publication
(10) Pub. No.: US 2020/0379288 A1
(43) Pub. Date: Dec. 3, 2020

(54) DISPLAY DEVICE HAVING LIGHT SOURCE

(71) Applicant: Samsung Display Co., LTD., Yongin-si (KR)

(72) Inventors: Jingyu SIM, Suwon-si (KR); Jeong-Min SEO, Yongin-si (KR)

(73) Assignee: Samsung Display Co., LTD., Yongin-si (KR)

(21) Appl. No.: 16/843,424

(22) Filed: Apr. 8, 2020

(30) Foreign Application Priority Data
May 30, 2019 (KR) 10-2019-0063917

(51) Int. Cl. G02F 1/1333; G02F 1/13357

(52) U.S. Cl. CPC G02F 1/133305; G02F 1/133605

(57) ABSTRACT

A display device includes a light source unit including a circuit board, a display panel to display an image, a reflection member disposed above the light source unit and reflecting light, emitted from the light source unit, back to the display panel, and a flexible circuit board disposed on one side of the circuit board. The reflection member includes a body part that overlaps the circuit board and a protrusion part that extends from one side of the body part and overlaps a portion of the flexible circuit board.

### CROSS-REFERENCE TO RELATED APPLICATIONS

This application claims priority to and the benefits of Korean Patent Application No. 10-2019-0063917 under 35 U.S.C. § 119, filed in the Korean Intellectual Property Office on May 30, 2019, the entire contents of which are incorporated herein by reference.

### BACKGROUND

### (a) Technical Field

The disclosure herein relates to a display device, and, to a display device including a light source.

### (b) Description of the Related Art

Multimedia apparatuses such as televisions, mobile phones, tablet computers, navigation devices, and game consoles include display devices for displaying images.

Liquid crystal display devices are a type of display device that are not self-light emissive. For example, a liquid crystal display device does not emit light on its own and typically requires a light source. Liquid crystal display devices are provided with a light source unit that includes a light source that provides light.

By disposing a light source below a display panel, the light source unit may provide the display panel with light emitted from the light source.

The display device may be provided with an optical member and a reflection member for improving the properties of the light provided from the light source unit. The optical member and the reflection member may be disposed between the display panel and the light source unit.

The light source unit may be operated in response to a control signal provided from a light source control circuit. The light source control circuit for controlling the light source unit may be provided in a separate substrate, and one side of a flexible printed circuit board may be connected to one side of the light source unit.

Reducing a dead space in which an image of a display device is not displayed has been the subject of recent technology. One of the methods for reducing the dead space is to bend a portion of the flexible printed circuit board such that the light source control circuit is made to be disposed below the light source unit. However, when bending a portion of the flexible printed circuit board, the flexible printed circuit board and the light source unit may be opened, separated, or detached or otherwise damaged.

It is to be understood that this background of the technology section is, in part, intended to provide useful background for understanding the technology. However, this background of the technology section may also include ideas, concepts, or recognitions that were not part of what was known or appreciated by those skilled in the pertinent art prior to a corresponding effective filing date of the subject matter disclosed herein.

### SUMMARY

The disclosure provides a display device having improved durability.

According to one or more embodiments, a display device includes a light source unit including a circuit board; a display panel to display an image; a reflection member disposed above the light source unit and reflecting light, emitted from the light source unit, back to the display panel; and a flexible circuit board disposed on one side of the circuit board, wherein the reflection member includes a body part that overlaps the circuit board and a protrusion part that extends from one side of the body part and overlaps the flexible circuit board.

In an embodiment, the protrusion part of the reflection member may include at least one protrusion that partially overlaps a portion of the flexible circuit board.

In an embodiment, a portion of the protrusion part of the reflection member may overlap the portion of the flexible circuit board.

In an embodiment, the portion of the protrusion part includes an inclined surface, and the body part and the protrusion part of the reflection member may be coupled to each other by the inclined surface.

In an embodiment, the protrusion part and the inclined surface may extend from the body part in a same direction.

In an embodiment, the flexible circuit board may be bent to cover the circuit board, and the portion of the protrusion part that overlaps the portion of the flexible circuit board.

In an embodiment, a surface of the reflection member may have an adhesive material to be in contact with the circuit board.

In an embodiment, the protrusion part of the reflection member may be bent to cover the circuit board and coupled to a bottom surface of the circuit board.

In an embodiment, the reflection member may have at least one insertion hole corresponding to a light emitting element of the light source unit, and the light emitting element may be inserted into the at least one insertion hole.

In an embodiment, the device may further include an optical member disposed between the reflection member and the display panel.

In an embodiment, one end of the flexible circuit board may be disposed on the one side of the circuit board, and the other end of the flexible circuit board may be connected to a main circuit board.

In an embodiment, the main circuit board may include a light source control circuit to control the light source unit.

In an embodiment, the protrusion part of the reflection member may include a first protrusion and a second protrusion, and the first protrusion and the second protrusion may be spaced apart from each other in a first direction.

In an embodiment, the first protrusion may be disposed adjacent to one side of the flexible circuit board, and the second protrusion may be disposed adjacent to another side of the flexible circuit board.

According to one or more embodiments, a display device may include a light source unit including a circuit board; a display panel to display an image; a reflection member disposed above the light source unit and reflecting light, emitted from the light source unit, back to the display panel; a flexible circuit board disposed on one side of the circuit board; and a protection member including a body part that overlaps the circuit board and a protrusion part that extends from one side of the body part and overlaps a portion of the flexible circuit board

In an embodiment, a portion of the protrusion part of the protection member may overlap the portion of the flexible circuit board.

In an embodiment, the portion of the protrusion part includes an inclined surface, and the body part and the protrusion part of the protection member may be coupled to each other by the inclined surface.

In an embodiment, the flexible circuit board may be bent to cover the circuit board, and the portion of the protrusion part that overlaps the portion of the flexible circuit board may be bent.

In an embodiment, one surface of the protection member may have an adhesive material to be in contact with the reflection member and the circuit board.

In an embodiment, the protrusion part of the protection member may be bent to cover the circuit board and coupled to a bottom surface of the circuit board.

In an embodiment, the device may further include an optical member disposed between the reflection member and the display panel.

In an embodiment, one end of the flexible circuit board may be disposed on the one side of the circuit board, the other end of the flexible circuit board may be connected to a main circuit board, and the main circuit board may include a light source control circuit to control the light source unit.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain principles of the disclosure. In the drawings:

FIG. 1 is an exploded perspective view of a display device according to an embodiment;

FIG. 2 is a diagram of an equivalent circuit of a light source unit according to an embodiment;

FIG. 3 is a perspective view of the light source unit and the reflection member illustrated in FIG. 1;

FIG. 4 is a plan view showing a coupled state in which the light source unit and the reflection member are coupled to each other;

FIG. 5 is a schematic cross-sectional view illustrating an XX region of FIG. 4 in a state in which the flexible circuit boards of FIG. 4 are bent;

FIG. 6 is a schematic cross-sectional view illustrating a YY region of FIG. 4 in a state in which the first to fifth protrusions of FIG. 4 are bent;

FIG. 7 is a schematic cross-sectional view illustrating a ZZ region of FIG. 4 in a state in which the flexible circuit boards and the first to fifth protrusions of FIG. 4 are bent;

FIG. 8 is a perspective view illustrating partial configurations of a display device according to an embodiment;

FIG. 9 is a plan view showing a coupled state in which the light source unit and the reflection member of FIG. 8 are coupled to each other;

FIG. 10 is a schematic cross-sectional view illustrating an XX′ region of FIG. 9 in a state in which the flexible circuit boards of FIG. 9 are bent;

FIG. 11 is a schematic cross-sectional view illustrating a YY′ region of FIG. 9 in an state in which the first to fifth protrusions of FIG. 9 are bent; and

FIG. 12 is a schematic cross-sectional view illustrating a ZZ′ region of FIG. 9 in a state in which the flexible circuit boards and the first to fifth protrusions of FIG. 9 are bent.

### DETAILED DESCRIPTION OF THE EMBODIMENTS

Embodiments of the invention will be described hereinafter with reference to the accompanying drawings. Although the disclosure may be modified in various manners and have additional embodiments, embodiments are illustrated in the accompanying drawings and will be mainly described in the specification. However, the scope of the disclosure is not limited to the embodiments in the accompanying drawings and the specification and should be construed as including all the changes, equivalents and substitutions included in the spirit and scope of the disclosure.

Some of the parts which are not associated with the description may not be provided in order to describe embodiments of the disclosure and like reference numerals refer to like elements throughout the specification.

In this specification, when a component, layer, portion, film, region, substrate, or area, is referred to as being “on”, “being connected to”, or “being coupled to” another component, layer, portion, film, region, substrate, or area, it may be directly on the other component, layer, portion, film, region, substrate, or area, or intervening components, layers, portions, films, regions, substrates, or areas, may be present therebetween. Conversely, when a component, portion, layer, film, region, substrate, or area, is referred to as being “directly on” another component, portion, layer, film, region, substrate, or area, intervening components, portions, layers, films, regions, substrates, or areas, may be absent therebetween. Further when a component, portion, layer, film, region, substrate, or area, is referred to as being “below” another component, portion, layer, film, region, substrate, or area, it may be directly below the other component, portion, layer, film, region, substrate, or area, or intervening components, portions, layers, films, regions, substrates, or areas, may be present therebetween. Conversely, when a component, portion, layer, film, region, substrate, or area, is referred to as being “directly below” another component, portion, layer, film, region, substrate, or area, intervening components, portions, layers, films, regions, substrates, or areas, may be absent therebetween. Further, “over” or “on” may include positioning on or below an object and does not necessarily imply a direction based upon gravity.

The spatially relative terms “below”, “beneath”, “lower”, “above”, “upper”, or the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in other directions and thus the spatially relative terms may be interpreted differently depending on the orientations.

Throughout the specification, when an element is referred to as being “connected” to another element, the element may be “directly connected” to another element, or “electrically connected” to another element with one or more intervening elements interposed therebetween. It will be further understood that when the terms “comprises,” “comprising,” “includes” and/or “including” are used in this specification, they or it may specify the presence of stated features, integers, steps, operations, elements and/or components, but do not preclude the presence or addition of other features, integers, steps, operations, elements, components, and/or any combination thereof.

Like numbers refer to like components throughout. Also, in the drawings, the thicknesses, ratios, and dimensions of the components may be exaggerated for clarity and or effectively describing the technical features.

Further, in the specification, the phrase “in a plan view” means when an object portion is viewed from above, and the phrase “in a schematic cross-sectional view” means when a schematic cross-section taken by vertically cutting an object portion is viewed from the side.

Additionally, the terms “overlap” or “overlapped” mean that a first object may be above or below or to a side of a second object, and vice versa. Additionally, the term “overlap” may include layer, stack, face or facing, extending over, covering or partly covering or any other suitable term as would be appreciated and understood by those of ordinary skill in the art. The terms “face” and “facing” mean that a first element may directly or indirectly oppose a second element. In a case in which a third element intervenes between the first and second element, the first and second element may be understood as being indirectly opposed to one another, although still facing each other. When an element is described as ‘not overlapping’ or ‘to not overlap’ another element, this may include that the elements are spaced apart from each other, offset from each other, or set aside from each other or any other suitable term as would be appreciated and understood by those of ordinary skill in the art.

In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.” In the specification and the claims, the phrase “at least one of” is intended to include the meaning of “at least one selected from the group of” for the purpose of its meaning and interpretation. For example, “at least one of A and B” may be understood to mean “A, B, or A and B.”

Although the terms such as first and second are used to describe various components, these components should not be limited by these terms. The terms are only used to distinguish one component from other components. For example, a first component may be referred to as a second component, and similarly a second component may be referred to as a first component without departing from the scope of the disclosure. The expression of a singular form may include plural forms unless otherwise defined in the specification.

Terms such as “below”, “on a lower side”, “above”, “on an upper side”, or the like may be used to describe the relationships of the components illustrated in the drawings. These terms are relative and are not necessarily limited to the directions illustrated in the drawings.

Unless otherwise defined, all terms (including technical and scientific terms) used herein have the same meaning as commonly understood by one of ordinary skill in the art to which the disclosure pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the specification.

It should be understood that the terms such as “comprise”, “comprising,” “have”, “includes” and/or “including”, when used in this specification specify the presence of a feature, a fixed number, a step, an operation, an element, a component, or a combination thereof described in the specification, but does not exclude the possibility of presence or addition of one or more other features, fixed numbers, steps, operations, elements, components, or combinations thereof. Further, the use of “may” when describing embodiments refers to “one or more embodiments.” Also, the term “exemplary” is intended to refer to an example or illustration.

Hereinafter, the disclosure will be explained in more detail with reference to the accompanying drawings.

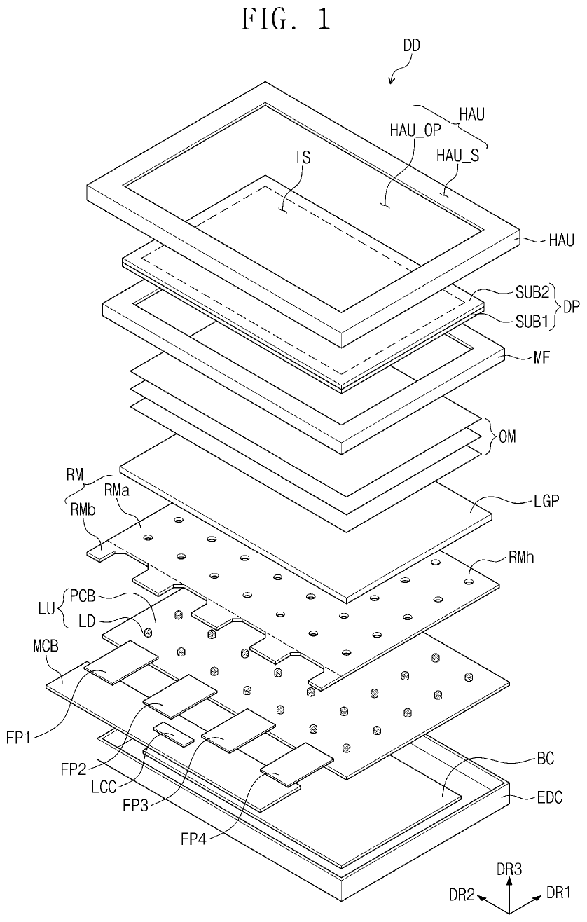

FIG. 1 is an exploded perspective view of a display device according to an embodiment.

Referring to FIG. 1, the display device DD according to an embodiment may include a display panel DP, a reflection member RM, and a light source unit LU. The display panel DP may overlap the light source unit LU. The display panel DP may be disposed above the light source unit LU, and the display device DD according to the embodiment may include a direct-type light source unit LU.

The display panel DP is a panel for displaying an image, and may include a liquid crystal display panel, an electrophoretic display panel, an organic light emitting diode display panel, a light emitting diode display panel, an inorganic electro luminescent display panel, a field emission display panel, a surface-conduction electron-emitter display panel, a plasma display panel, or a cathode ray tube display panel. Hereinafter, the display device according to an embodiment will be described, for example, as a liquid crystal display device, and the display panel DP is also described as a liquid crystal display panel. However, the display device and the display panel DP according to an embodiment are not limited thereto, and various types of display devices and display panels may be used.

The display panel DP may display an image through a display surface IS. The display surface IS may be parallel to a plane defined by a first direction axis DR1 and a second direction axis DR2. The normal direction of the display surface IS, that is, the thickness direction of the display panel DP is indicated as a third direction axis DR3.

A front surface (or a top surface) and a rear surface (or a bottom surface) in each of members or units described below are distinguished by the third direction axis DR3. However, the first to third direction axes DR1, DR2, and DR3 are merely examples. Hereinafter, first to third directions are defined as the directions indicated by the first to third direction axes DR1, DR2, and DR3, respectively, and referred to as the same reference elements.

The display panel DP according to an embodiment is illustrated as having, for example, a flat shape, but in an embodiment, the display panel DP may be a curved display panel with a curved display surface. The shape of the display panel DP is not particularly limited.

The display panel DP according to an embodiment may include a first substrate SUB1 and a second substrate SUB2 facing each other. Each of the first substrate SUB1 and the second substrate SUB2 may have a substantially rectangular parallelepiped shape. In FIG. 1, the first substrate SUB1 and the second substrate SUB2 are illustrated as having rectangular parallelepiped shapes for convenience of explanation. However, the embodiment is not limited thereto, and the first substrate SUB1 and the second substrate SUB2 may be manufactured in various shapes according to the shape of the display panel DP.

A signal line and a pixel circuit for pixels may be formed on an array substrate of the first substrate SUB1 or the second substrate SUB2. The array substrate may be connected to a driving circuit board through a chip on film (COF) or the like. A control circuit for driving the display panel DP may be disposed on the driving circuit board. The control circuit may be a microprocessor. A chip of the COF may be a data driving circuit. A gate driving circuit may be mounted on the array substrate or integrated on the array substrate in a form of low temperature poly-silicon (LTPS).

A liquid crystal layer (not shown) may be disposed between the first substrate SUB1 and the second substrate SUB2. Also, a sealing member (not shown) such as a sealant may be disposed between the first substrate SUB1 and the second substrate SUB2 along edge portions of the first substrate SUB1 and the second substrate SUB2, whereby the first substrate SUB1 and the second substrate SUB2 may be adhered to each other and sealed.

Although not illustrated in FIG. 1, the display panel DP may include a flexible circuit board and a driving unit coupled to the first substrate SUB1 and the second substrate SUB2. The driving unit may generate a driving signal for displaying an image on a display area and apply the driving signal to elements on the display area. The flexible circuit board may be connected to an external control device, a power supply, or the like, and apply various external signals or the like to the driving unit.

The display device DD according to an embodiment may include a housing HAU and an outer case EDC. The housing HAU may generally be disposed above the display panel DP. In the display device DD according to an embodiment, the outer case EDC and the housing HAU may be coupled to each other to accommodate the display panel DP and the light source unit LU. The housing HAU may be composed of a metal or plastic or other material within the spirit and scope of the disclosure.

The housing HAU may be disposed above the display panel DP to cover edge regions of the display panel DP. The housing HAU may include an opening part HAU-OP through which an image is provided and a side wall part HAU-S. The side wall part HAU-S may be a rectangular frame on a plane or plan view.

The display device DD may further include a mold frame MF between the outer case EDC and the housing HAU. The mold frame MF may support the display panel DP or the like to allow the display panel DP to be spaced at a predetermined interval from the light source unit LU.

The light source unit LU may be disposed below the display panel DP. The light source unit LU may provide the display panel DP with light. The light source unit LU may include a circuit board PCB and light emitting elements LD.

The circuit board PCB may be interposed between the mold frame MF and the outer case EDC to support the light emitting elements LD, and may transmit voltage and various signals to the light emitting elements LD. The circuit board PCB may have a plate shape of that of a rectangular parallelepiped. The circuit board PCB may be an organic substrate capable of little or reduced thermal deformation. However, the embodiment is not limited thereto, and the circuit board PCB may be substituted with a transparent synthetic resin substrate having a high heat resistance.

The light emitting elements LD may be mounted on the circuit board PCB. These light emitting elements LD may receive voltage from the outside to generate light that is transmitted to the display panel DP. The light emitting elements LD may be located on the same plane. In an embodiment, each of the light emitting elements LD may be a light emitting diode (LED). However, the embodiment is not limited thereto, and the light emitting elements LD may mean all elements capable of emitting light and not only light emitting diodes (LEDs). In an embodiment, the light emitting elements LD may be arranged in a matrix form. However, the disclosure is not limited thereto, and the arrangement thereof may be changed according to a shape of the display panel DP.

Each of the light emitting elements LD may emit blue light. In an embodiment, each of the light emitting elements LD may be a blue light emitting diode including a gallium nitride-based semiconductor. However, the disclosure is not limited thereto, and the light emitting elements LD may mean all elements capable of emitting blue light. The light emitting elements may emit light of other colors or white light and are thus not limited to emitting blue light.

Each of the light emitting elements LD may include a top emitting-type lens. For example, the light generated in each of the light emitting elements LD may be discharged upward from the light emitting elements LD. For example, the light source unit LU according to an embodiment may be a top view-type backlight assembly.

The display device DD may include a main circuit board MCB and flexible circuit boards FP1 to FP4. The main circuit board MCB may be electrically connected to the circuit board PCB through the flexible circuit boards FP1 to FP4. The flexible circuit boards FP1 to FP4 may function as connection boards. One end of each of the flexible circuit boards FP1 to FP4 may be coupled to the circuit board PCB, and the other end thereof and the circuit board PCB may be coupled to the main circuit board MCB. In an embodiment, the number of the flexible circuit boards FP1 to FP4 connected between the circuit board PCB and the main circuit board MCB is four, but the number of the flexible circuit boards FP1 to FP4 is not limited thereto. The flexible circuit boards FP1 to FP4 may be coupled to a long side of the circuit board PCB as illustrated for example in FIG. 1, but an embodiment is not limited thereto. For example, the flexible circuit boards FP1 to FP4 may be coupled to a short side of the circuit board PCB.

Although not illustrated in the drawing, the flexible circuit boards FP1 to FP4 may further include signal lines to electrically connect the circuit board PCB and the main circuit board MCB. Each of the flexible circuit boards FP1 to FP4 may be a flexible printed circuit board (FPCB).

A light source control circuit LCC may be provided in the main circuit board MCB. The light source control circuit LCC may output control signals to control the light emitting elements LD. The control signals generated from the light source control circuit LCC may be transmitted to the light emitting elements LD through the main circuit board MCB, the flexible circuit boards FP1 to FP4, and the circuit board PCB. The light emitting elements LD may be turned on/off in response to the control signals from the light source control circuit LCC. The light source control circuit LCC may be an integrated circuit (IC) and mounted on the main circuit board MCB. Although not illustrated in the drawing, a control circuit for driving the display panel DP may also be mounted on the main circuit board MCB. As an example, the display panel DP and the main circuit board MCB may be electrically connected to each other through a COF or the like.

Although FIG. 1 illustrates that the light emitting elements LD are arranged at a constant interval or regular or the same interval, an embodiment is not limited thereto, and the arrangement interval between or among the light emitting elements LD may vary with respect to a central region, a border region, or the like of the display panel DP. Accordingly, the arrangement intervals of the light emitting elements LD may vary and is not limited to that which is illustrated in the figures. The light emitting elements LD may be arranged at any intervals within the spirit and scope of the disclosure.

The display device DD may further include an optical member OM, a diffusion plate LGP, and the reflection member RM which may be disposed between the display panel DP and the light source unit LU.

The reflection member RM may be interposed between the diffusion plate LGP and the light source unit LU. The reflection member RM may change or alter a path of light emitted from the light source unit LU and as the light emitted from the light source unit LU travels toward the outer case EDC so that the light is directed toward the diffusion plate LGP.

The reflection member RM may include insertion holes RMh. The insertion holes RMh may correspond to the light emitting elements LD, respectively. For example, the light emitting elements LD may be inserted into the insertion holes RMh, respectively.

The diffusion plate LGP may be positioned above the reflection member RM. As an example, the diffusion plate LGP may be positioned between the optical member OM and the reflection member RM. The diffusion plate LGP may improve the uniformity of luminance of light incident from the light source unit LU.

The optical member OM may be disposed above the diffusion plate LGP. As an example, the optical member OM may be disposed between the display panel DP and the diffusion plate LGP. The optical member OM may modulate the optical characteristics of light that is emitted from the light source unit LU and passes through the diffusion plate LGP. The optical member OM may be provided in plurality, and as illustrated in FIG. 1, the optical members OM may be stacked while overlapping each other. For example, the optical members OM may include a prism sheet or the like within the spirit and scope of the disclosure.

The mold frame MF may be disposed between the display panel DP and the optical member OM. The mold frame MF may be engaged with the outer case EDC to fix the optical member OM, the light source unit LU, the diffusion plate LGP, and the reflection member RM. The mold frame MF may be in contact with an edge portion of the display panel DP to support and fix the display panel DP.

The display device DD may include a bottom chassis BC between the light source unit LU and the outer case EDC. The bottom chassis BC may be coupled to the outer case EDC to divide the inner space of the display device DD. The bottom chassis BC may provide a space in which other components may be disposed. The bottom chassis BC may support the circuit board PCB so that the circuit board PCB is fixed or stable without shaking or otherwise being moved.

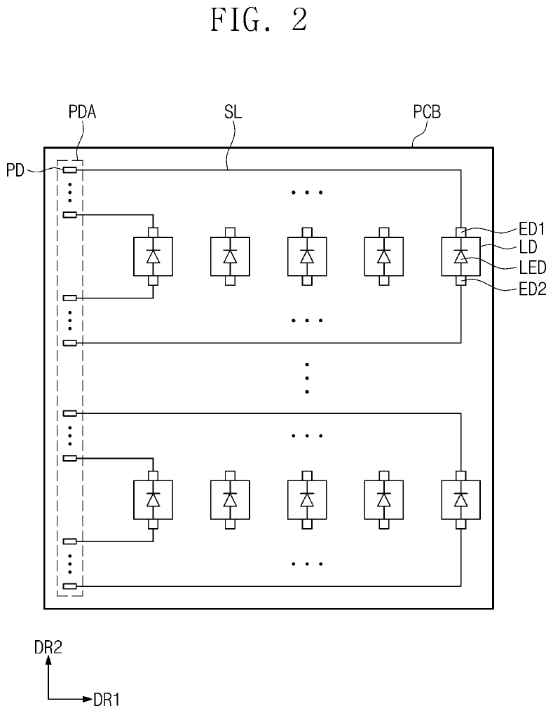

FIG. 2 is diagram of an equivalent circuit of a light source unit LU according to an embodiment.

Referring to FIG. 2, each light source unit LU includes light emitting elements LD and a circuit board PCB. In FIG. 2, for ease of understanding and for clarity, not all of the light emitting elements LD are illustrated. As illustrated in FIG. 2, the light emitting elements LD are connected to signal lines SL, respectively, to enable dimming of the light emitting elements LD.

The circuit board PCB may have a substantially rectangular shape that may be defined by a first direction DR1 and a second direction DR2. The light emitting elements LD may be arranged, for example, in a matrix form, in the first direction DR1 and the second direction DR2. The circuit board PCB may include a pad area PDA in which pads PD may be arranged or disposed.

Each of the light emitting elements LD may include a light emitting diode LED. The light emitting diode LED generates light in response to a driving voltage applied through a first electrode ED1 and a second electrode ED2. The light emitting diode LED may have a structure in which an n-type semiconductor layer, an active layer, a p-type semiconductor layer are stacked in this order. However, the disclosure is not limited thereto.

The first electrode ED1 may be connected to one of the connection terminals, and the second electrode ED2 may be connected to another one of the connection terminals. Each of the first electrode ED1 and the second electrode ED2 may be connected to each of the signal lines SL.

The signal lines SL are connected to the pads PD, respectively. The pads PD may be electrically connected to the main circuit board MCB through the flexible circuit boards FP1 to FP4 of FIG. 1.

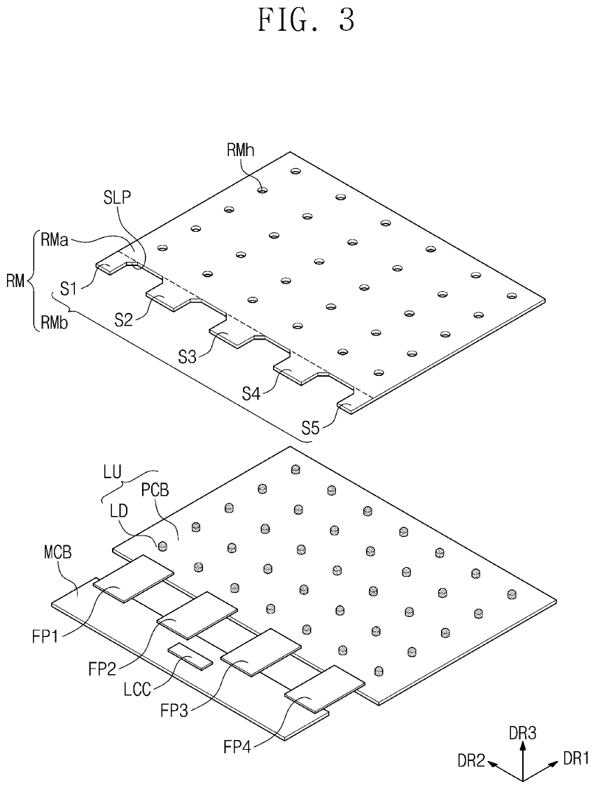

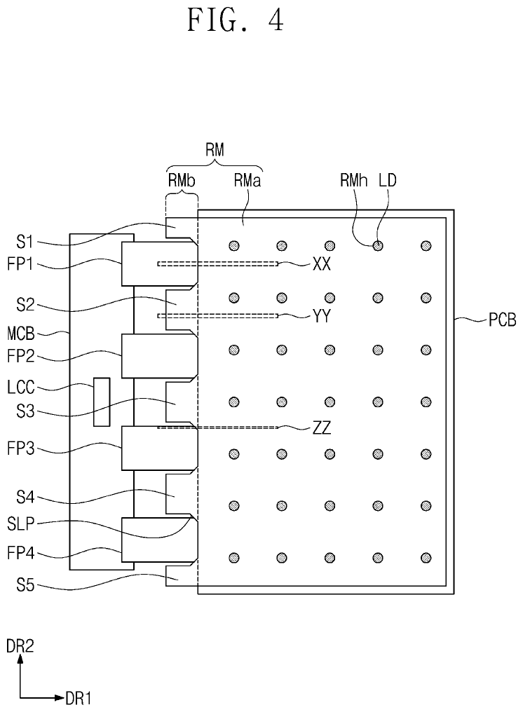

FIG. 3 is a perspective view of the light source unit and the reflection member of FIG. 1. FIG. 4 is a plan view showing a coupled state in which the light source unit and the reflection member are coupled to each other.

Referring to FIG. 3 and FIG. 4, the reflection member RM may be disposed on the circuit board PCB. The reflection member RM may include a body part RMa and a protrusion part RMb. The body part RMa may overlap the circuit board PCB. The protrusion part RMb extends from one side of the body part RMa. The protrusion part RMb may include first to fifth protrusions S1 to S5. However, the number of the protrusions extending from the body part RMa of the reflection member RM may be changed according to the number of the flexible circuit boards FP1 to FP4. For example, the number of the protrusions may be greater by one than the number of the flexible circuit boards. In an embodiment, the number of the protrusions may be less than or equal to the number of the flexible circuit boards. The first to fifth protrusions S1 to S5 may be spaced apart from each other in the second direction DR2. In an embodiment, since the flexible circuit boards FP1 to FP4 are connected to the long side of the circuit board PCB, the first to fifth protrusions S1 to S5 are also disposed along a long side of the reflection member RM. However, when the flexible circuit boards FP1 to FP4 are disposed on the short side of the circuit board PCB, the first to fifth protrusions S1 to S5 may also be disposed along a short side of the reflection member RM.

The first to fifth protrusions S1 to S5 may be disposed on the left sides and the right sides of the flexible circuit boards FP1 to FP4. The left side of each of the flexible circuit boards FP1 to FP4 may be defined as one side, and the right side may be defined as the other side. For example, the first protrusion S1 may be disposed on the one side of the flexible circuit board FP1, and the second protrusion S2 may be disposed on the other side. The second protrusion S2 may be disposed on the one side of the flexible circuit board FP2, and the third protrusion S3 may be disposed on the other side. The third protrusion S3 may be disposed on the one side of the flexible circuit board FP3, and the fourth protrusion S4 may be disposed on the other side. The fourth protrusion S4 may be disposed on the one side of the flexible circuit board FP4, and the fifth protrusion S5 may be disposed on the other side. In other words, the protrusions S1-S5 may alternate with the flexible circuit boards FP1-FP4.

The body part RMa of the reflection member RM may overlap some portions of the flexible circuit boards FP1 to FP4 that overlap the circuit board PCB.

The bottom surface of the reflection member RM, that is, a surface coupled to the circuit board PCB may have an adhesive material. When the reflection member RM is coupled to the circuit board PCB, a portion of the body part RMa of the reflection member RM may be coupled to some portions of the flexible circuit boards FP1 to FP4 and may fix or stabilize the flexible circuit boards FP1 to FP4.

The body part RMa of the reflection member RM may be coupled to each of the first to fifth protrusions S1-S5 by an inclined surface SLP. In other words, each of the first to fifth protrusions S1-S5 and the inclined surface SLP may extend from the body part RMa in a same direction (for example, direction DR1 in FIG. 4). When the reflection member RM is coupled to the circuit board PCB, the inclined surfaces SLP of the first to fifth protrusions S1 to S5 overlap the flexible circuit boards FP1 to FP4. Thus, some portions, having the inclined surfaces SLP, of the first to fifth protrusions S1 to S5 may be coupled to some portions of the flexible circuit boards FP1 to FP4.

The flexible circuit boards FP1 to FP4 may be bent in a direction toward the bottom surface of the circuit board PCB. The first to fifth protrusions S1 to S5 may also be bent in the direction toward the bottom surface of the circuit board PCB.

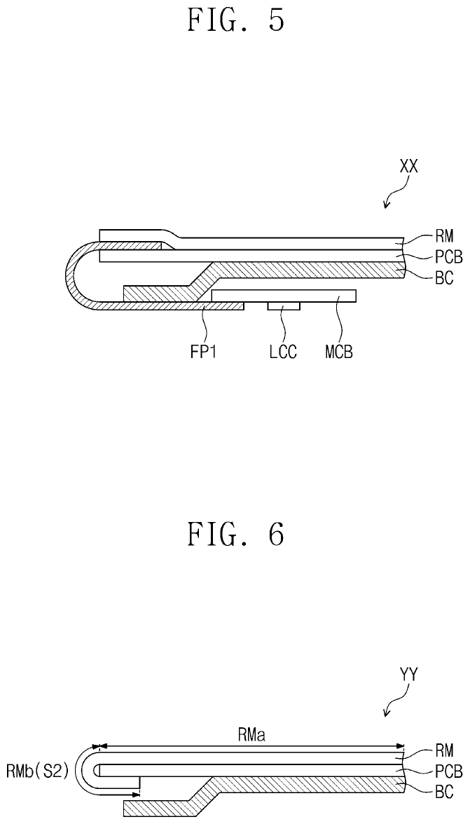

FIG. 5 is a schematic cross-sectional view illustrating an XX region of FIG. 4 in a state in which the flexible circuit boards FP1 to FP4 of FIG. 4 are bent.

Referring to FIG. 5, the flexible circuit board FP1 is bent in the direction toward the bottom surface of the circuit board PCB. A portion of the flexible circuit board FP1 may be disposed below the bottom chassis BC.

The body part RMa of the reflection member RM may be coupled to the top surface of the circuit board PCB and a portion of the top surface of the flexible circuit board FP1. The bottom surface of the reflection member RM may have an adhesive material, and thus may fix or stabilize the flexible circuit board FP1. A stress may increase at a bent portion of the flexible circuit board FP1 when the flexible circuit board FP1 is bent, thus, the flexible circuit board FP1 may be separated or detached from the circuit board PCB, or a crack may occur at the bent portion. In an embodiment, the reflection member RM may be coupled to the top surface of the flexible circuit board FP1, and may prevent the flexible circuit board FP1 from being separated or detached from the circuit board PCB or may prevent a defect from occurring.

FIG. 6 is a schematic cross-sectional view illustrating a YY region of FIG. 4 in a state in which the first to fifth protrusions S1-S5 of FIG. 4 are bent.

Referring to FIG. 6, the body part RMa of the reflection member RM is coupled to the top surface of the circuit board PCB. The protrusion part RMb (the second protrusion S2 in FIG. 4) of the reflection member RM is bent in the direction toward the bottom surface of the circuit board PCB and coupled to the bottom surface of the circuit board PCB. The bottom surface of the reflection member RM has an adhesive material, thus, the reflection member RM may be coupled to not only the top surface of the one side of the circuit board PCB but also the bottom surface thereof.

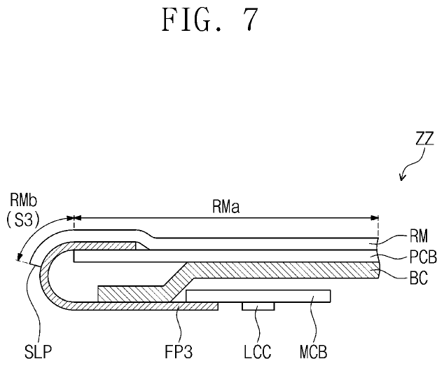

FIG. 7 is a schematic cross-sectional view illustrating a ZZ region of FIG. 4 in a state in which the flexible circuit boards FP1 to FP4 and the first to fifth protrusions S1 to S5 of FIG. 4 are bent.

Referring to FIG. 7, the body part RMa of the reflection member RM is coupled to the top surface of the circuit board PCB and a portion of the top surface of the flexible circuit board FP3. A portion, having the inclined surface SLP, of the protrusion part RMb (the third protrusion S3 in FIG. 4) of the reflection member RM may be coupled to the top surface of the flexible circuit board FP3.

When the flexible circuit board FP3 is bent in the direction toward the bottom surface of the circuit board PCB, the portion, having the inclined surface SLP, of the protrusion part RMb of the reflection member RM may be bent together with the flexible circuit board FP3. The protrusion part RMb of the reflection member RM may be coupled to the top surface of a bent region of the flexible circuit board FP3 while wrapping the top surface, and thus may prevent the flexible circuit board FP3 from being separated or detached from the circuit board PCB or may prevent a defect from occurring. The protrusion part RMb of the reflection member RM may wrap the top surface of the flexible circuit board in a substantially c-shape. It is to be understood that the term wrap or wrapping may include cover or enclose or partially cover or partially enclose or fit around or partially fit around.

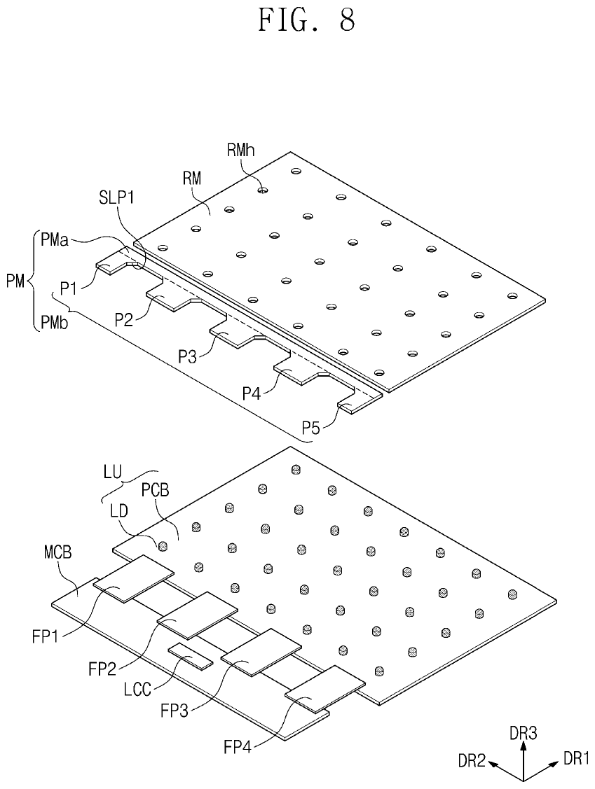

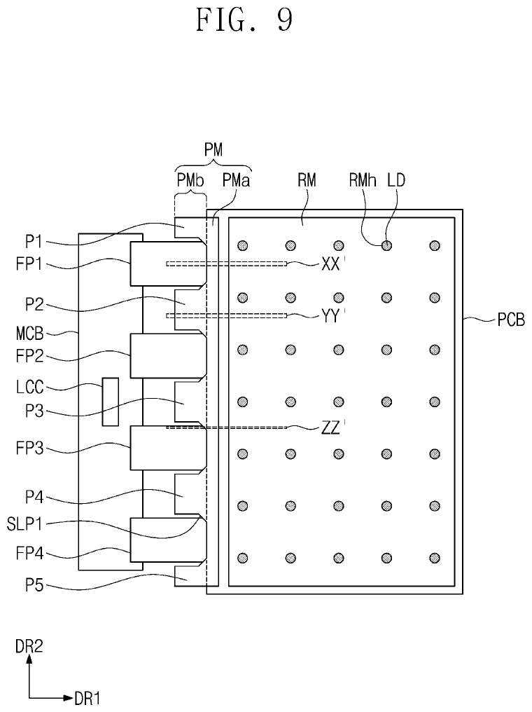

FIG. 8 is a perspective view illustrating partial configurations of a display device according to an embodiment. FIG. 9 is a plan view showing a coupled state in which the light source unit and the reflection member of FIG. 8 are coupled to each other.

Referring to FIG. 8 and FIG. 9, a reflection member RM may be disposed on a circuit board PCB. A protection member PM may be disposed on the same layer of the reflection member RM. The protection member PM may be spaced apart from the reflection member RM by a predetermined distance in a first direction DR1. In another embodiment, the protection member PM may overlap a portion of the reflection member RM. For example, a portion of the protection member PM may be coupled to the top surface of the reflection member RM.

The protection member PM may include a body part PMa and a protrusion part PMb. The body part PMa may overlap the circuit board PCB. The protrusion part PMb may extend from one side of the body part PMa. The protrusion part PMb may include first to fifth protrusions P1 to P5. The number of the protrusions extending from the body part PMa of the protection member PM may vary or be changed according to the number of the flexible circuit boards FP1 to FP4. For example, the number of the protrusions may be greater by one than the number of the flexible circuit boards. In an embodiment, the number of the protrusions may be less than or equal to the number of the flexible circuit boards. The first to fifth protrusions P1 to P5 may be spaced apart from each other in a second direction DR2.

The first to fifth protrusions P1 to P5 may be disposed on the left sides and the right sides of the flexible circuit boards FP1 to FP4. The left side of each of the flexible circuit boards FP1 to FP4 may be defined as one side, and the right side may be defined as the other side. For example, the first protrusion P1 may be disposed on the one side of the flexible circuit board FP1, and the second protrusion P2 may be disposed on the other side. The second protrusion P2 may be disposed on the one side of the flexible circuit board FP2, and the third protrusion P3 may be disposed on the other side. The third protrusion P3 may be disposed on the one side of the flexible circuit board FP3, and the fourth protrusion P4 may be disposed on the other side. The fourth protrusion P4 may be disposed on the one side of the flexible circuit board FP4, and the fifth protrusion P5 may be disposed on the other side.

The body part PMa of the protection member PM may overlap some portions of the flexible circuit boards FP1 to FP4 that overlap the circuit board PCB.

Each of the bottom surface of the reflection member RM and the bottom surface of the protection member PM, that is, each of the surfaces coupled to the circuit board PCB may have an adhesive material. When the protection member PM is coupled to the circuit board PCB, a portion of the body part PMa of the protection member PM may be coupled to some portions of the flexible circuit boards FP1 to FP4 and fix or stabilize the flexible circuit boards FP1 to FP4.

The body part PMa of the protection member PM may be coupled to each of the first to fifth protrusions P1-P5 by an inclined surface SLP1. In other words, each of the first to fifth protrusions P1-P5 and the inclined surface SLP1 may extend from the body part PMa in a same direction (for example, direction DR1 in FIG. 9).When the protection member PM is coupled to the circuit board PCB, the inclined surfaces SLP1 of the first to fifth protrusions P1 to P5 may overlap the flexible circuit boards FP1 to FP4. Thus, some portions, having the inclined surfaces SLP1, of the first to fifth protrusions S1 to S5 may be coupled to some portions of the flexible circuit boards FP1 to FP4.

The flexible circuit boards FP1 to FP4 may be bent in a direction toward the bottom surface of the circuit board PCB. As an example, the first to fifth protrusions P1 to P5 of the protection member PM may also be bent in the direction toward the bottom surface of the circuit board PCB.

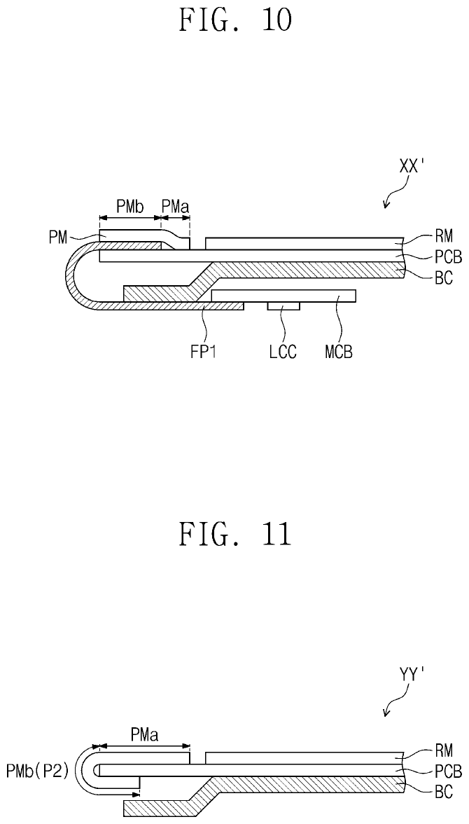

FIG. 10 is a schematic cross-sectional view illustrating an XX′ region of FIG. 9 in a state in which the flexible circuit boards FP1 to FP4 of FIG. 9 are bent.

Referring to FIG. 10, the flexible circuit board FP1 may be bent in the direction toward the bottom surface of the circuit board PCB. A portion of the flexible circuit board FP1 may be disposed below the bottom chassis BC.

The body part PMa of the protection member PM may be coupled to the top surface of the circuit board PCB and a portion of the top surface of the flexible circuit board FP1. The bottom surface of the protection member PM may have an adhesive material, and thus may fix or stabilize the flexible circuit board FP1. A stress may increase at a bent portion of the flexible circuit board FP1 when the flexible circuit board FP1 is bent, thus, the flexible circuit board FP1 may be separated or detached from the circuit board PCB, or a crack may occur at the bent portion. In an embodiment, the protection member PM may be coupled to the top surface of the flexible circuit board FP1, and may prevent the flexible circuit board FP1 from being separated or detached from the circuit board PCB or may prevent a defect from occurring.

FIG. 11 is a schematic cross-sectional view illustrating a YY' region of FIG. 9 in a state in which the first to fifth protrusions P1-P5 of FIG. 9 are bent.

Referring to FIG. 11, the body part PMa of the protection member PM may be coupled to the top surface of the circuit board PCB. The protrusion part PMb (the second protrusion P2 in FIG. 9) of the protection member PM is bent in the direction toward the bottom surface of the circuit board PCB and coupled to the bottom surface of the circuit board PCB. The bottom surface of the protection member PM has an adhesive material, thus, the protection member PM may be coupled to not only the top surface of the one side of the circuit board PCB but also the bottom surface thereof.

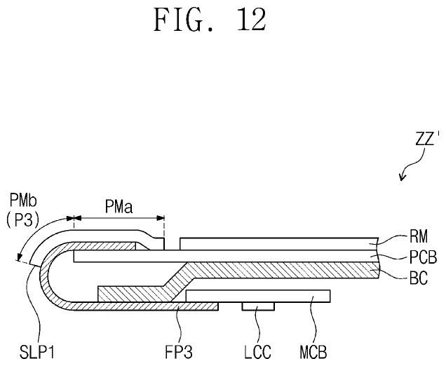

FIG. 12 is a schematic cross-sectional view illustrating a ZZ′ region of FIG. 9 in a state in which the flexible circuit boards FP1 to FP4 and the first to fifth protrusions P1 to P5 of FIG. 9 are bent.

Referring to FIG. 12, the body part PMa of the protection member PM may be coupled to the top surface of the circuit board PCB and a portion of the top surface of the flexible circuit board FP3. A portion, having the inclined surface SLP1, of the protrusion part PMb (the third protrusion P3 in FIG. 9) of the protection member PM may be coupled to the top surface of the flexible circuit board FP3.

When the flexible circuit board FP3 is bent in the direction toward the bottom surface of the circuit board PCB, the portion, having the inclined surface SLP1, of the protrusion part PMb of the protection member PM is bent together with the flexible circuit board FP3. The protrusion part PMb of the protection member PM may be coupled to the top surface of a bent region of the flexible circuit board FP3 while wrapping the top surface, and thus may prevent the flexible circuit board FP3 from being separated or detached from the circuit board PCB or may prevent a defect from occurring.

In the display device having the above-described configurations, the reflection member disposed above the light source unit may extend to cover the portion of the flexible circuit board. Thus, the separation or detachment of the flexible circuit board from the light source unit may be prevented when the flexible circuit board is bent. The protrusion part of the reflection member may bend while wrapping the light source unit, and thus may more stably fix the flexible circuit board. Thus, the separation or detachment of the flexible circuit board from the light source unit or the occurrence of a defect may be prevented.

Although the embodiments of the disclosure have been described, it is understood that various changes and modifications may be made by one of ordinary skill in the art without departing from the spirit and scope of the disclosure. The embodiments disclosed in the disclosure are not intended to limit the disclosure, and all embodiments and variations within the following claims and their equivalents should be interpreted to be included in the scope of the disclosure.

1. A display device comprising:
a light source unit comprising a circuit board;
a display panel to display an image;
a reflection member disposed above the light source unit and reflecting light, emitted from the light source unit, back to the display panel; and
a flexible circuit board disposed on one side of the circuit board,
wherein the reflection member comprises:
a body part that overlaps the circuit board; and
a protrusion part that extends from one side of the body part and overlaps a portion of the flexible circuit board.

2. The display device of claim 1, wherein the protrusion part of the reflection member includes at least one protrusion that partially overlaps a portion of the flexible circuit board.

3. The display device of claim 1, wherein a portion of the protrusion part of the reflection member overlaps the portion of the flexible circuit board.

4. The display device of claim 3, wherein
the portion of the protrusion part includes an inclined surface, and
the body part and the protrusion part of the reflection member are coupled to each other by the inclined surface.

5. The display device of claim 4, wherein the protrusion part and the inclined surface extend from the body part in a same direction.

6. The display device of claim 3, wherein
the flexible circuit board is bent to cover the circuit board, and
the portion of the protrusion part that overlaps the portion of the flexible circuit board is bent.

7. The display device of claim 1, wherein a surface of the reflection member has an adhesive material to be in contact with the circuit board.

8. The display device of claim 7, wherein the protrusion part of the reflection member is bent to cover the circuit board and coupled to a bottom surface of the circuit board.

9. The display device of claim 1, wherein
the reflection member has at least one insertion hole corresponding to a light emitting element of the light source unit, and
the light emitting element is inserted into the at least one insertion hole.

10. The display device of claim 1, further comprising an optical member disposed between the reflection member and the display panel.

11. The display device of claim 1, wherein
one end of the flexible circuit board is disposed on the one side of the circuit board, and
the other end of the flexible circuit board is connected to a main circuit board.

12. The display device of claim 11, wherein the main circuit board comprises a light source control circuit to control the light source unit.

13. The display device of claim 1, wherein
the protrusion part of the reflection member comprises a first protrusion and a second protrusion, and
the first protrusion and the second protrusion are spaced apart from each other in a first direction.

14. The display device of claim 13, wherein
the first protrusion is disposed adjacent to one side of the flexible circuit board, and
the second protrusion is disposed adjacent to another side of the flexible circuit board.

15. A display device comprising:
a light source unit comprising a circuit board;
a display panel to display an image;
a reflection member disposed above the light source unit and reflecting light, emitted from the light source unit, back to the display panel;
a flexible circuit board disposed on one side of the circuit board; and
a protection member comprising:
a body part that overlaps the circuit board; and
a protrusion part that extends from one side of the body part and overlaps a portion of the flexible circuit board.

16. The display device of claim 15, wherein a portion of the protrusion part of the protection member overlaps the portion of the flexible circuit board.

17. The display device of claim 16, wherein
the portion of the protrusion part includes an inclined surface, and
the body part and the protrusion part of the protection member are coupled to each other by the inclined surface.

18. The display device of claim 16, wherein
the flexible circuit board is bent to cover the circuit board, and
the portion of the protrusion part that overlaps the portion of the flexible circuit board is bent.

19. The display device of claim 15, wherein a surface of the protection member has an adhesive material to be in contact with the reflection member and the circuit board.

20. The display device of claim 19, wherein the protrusion part of the protection member is bent to cover the circuit board and coupled to a bottom surface of the circuit board.

21. The display device of claim 15, further comprising an optical member disposed between the reflection member and the display panel.

22. The display device of claim 15, wherein
one end of the flexible circuit board is disposed on the one side of the circuit board,
the other end of the flexible circuit board is connected to a main circuit board, and
the main circuit board comprises a light source control circuit to control the light source unit.
